(19) United States
(12) Patent Application Publication
(10) Pub. No.: US 2008/0201717 A1
(43) Pub. Date: Aug. 21, 2008

(54) OPTIMIZATION AND/OR SCHEDULING FRAMEWORK FOR A PERIODIC DATA COMMUNICATION SYSTEM HAVING MULTIPLE BUSES AND HARDWARE APPLICATION MODULES

(76) Inventors: Mangesh D. Kapadi, Bangalore (IN); Sudarshan Yermal, Taluk and District Udupi (IN); Lingathurai Palanisamy, Bangalore (IN); Gowri Ganesan, Bangalore (IN)

Correspondence Address: HONEYWELL INTERNATIONAL INC., 101 COLUMBIA ROAD, P O BOX 2245, MORRISTOWN, NJ, 07962-2245, US

(21) Appl. No.: 11/677,121

(22) Filed: Feb. 21, 2007

(51) Int. Cl. G06F 9/46

(52) U.S. Cl. 718/105

(57) ABSTRACT

Periodic communication of data packets between modules in time frames having a plurality of frame rates including a base frame rate through a bus is schedule by determining a first load schedule for data packets of base frame and half base frame rates using constraint logic programming techniques, by determining a second load schedule for data packets of other frame rates using mixed integer linear programming techniques, and by scheduling produce and consume loads for each of the modules based on the first and second load schedules.

### TECHNICAL FIELD

The present application relates to an optimization and/or scheduling framework such as may be used for a periodic data communication system having multiple buses and/or hardware application modules.

### BACKGROUND

In a typical periodic bus communication system, different processing modules are connected to each other through a bus network. The individual modules run multiple applications on their processors depending on their memory and/or processing capabilities.

The applications running on a module may need to use the communication bus in order to share data and/or results with, or query data and/or results from, applications running on other modules. Hence, the processing modules perform read and/or write operations over the communication bus.

The prioritization of a module between its applications is dependent upon the applications that it is running. The data exchange requirement combined with this prioritization form the basis for scheduling the load on each module for its Input/Output operations in order to increase the processing budget for the applications actually running.

Some bus schedulers that are used in systems having modules that communicate with one another over a set of read/write buses rely on heuristic approaches to schedule their periodic communication packets of different frequencies across data frames. The heuristic approach leads to situations where the distribution of load throughout the time frames is undirected and can result in abnormally high peak loads for some of the time frames.

Accordingly, the present invention solves this or other problems.

### SUMMARY OF THE INVENTION

According to one aspect of the present invention, a method is provided for scheduling periodic communication between modules of data in time frames having a plurality of frame rates including a base frame rate. The method comprises the following: determining a first load schedule for data packets of base frame and half base frame rates using constraint logic programming techniques; determining a second load schedule for data packets of other frame rates using mixed integer linear programming techniques; and, scheduling produce and consume loads for each of the modules based on the first and second load schedules.

### BRIEF DESCRIPTION OF THE DRAWINGS

These and other features and advantages will become more apparent from the detailed description below when taken in conjunction with the drawings in which:

FIG. 1 illustrates a load scheduler in accordance with an embodiment of the present invention;

FIG. 2 illustrates a program that may be executed by the load scheduler of FIG. 2; and

FIG. 3 illustrates a network providing one example of an environment for the present invention.

### DETAILED DESCRIPTION

An optimized module load leveling scheduler can be used to schedule periodic data packets in multiple frames and can be used for both the production side and the consumption side of a communication in order to reduce and/or minimize peak loads. Applications performing different functionalities are executed by the processors of the modules connected to the network bus. These modules read and/or write data across frames transmitted over the bus with the use of a Network Interface Controller and/or card.

The overhead on a driver to transmit and receive data along with integrity checks such as a checksum, CRC, etc. for a module may be referred to as load. In other words, load may be thought of as the size of the data packets per unit of time (i.e., time frame) that are communicated over the buses.

Load can be divided into two categories, the input or consume load on a module and the output or produce load on a module. Because the modules connected to the bus or buses may have different configurations, it cannot be assumed when scheduling the data on a bus that all processes performed by the modules are similar. Hence, the scheduler described below provides the user with the flexibility to set priorities for the module processors based on type of module, the applications running on the module, and the criticality, cost, strength, etc. of the module, all of which are used to decide the data scheduling pattern.

The applications on a module may be changed from time to time. However, for a given instance of scheduling, the applications running on the module are assumed to be fixed. Also, the consume priority assigned to a module may be different from the produce priority assigned to that module.

Also, the worst case scheduled frame loading for each individual module constrains the processing budget available for the applications running on that module. Accordingly, an attempt is made to reduce the worst case frame loading on each module so that the performance of the module can be increased and other critical applications running on the module will get more budget.

A communication system, which requires periodic transmission of data over a data bus between modules and/or nodes, is arranged to impose restrictions that all data transmission periods begin with frame 0 and that the number of base-rate frames in each period is an integer factor of the total number of frames in a hyperperiod. A hyperperiod is a set of frames over which data is scheduled.

The schedule repeats each hyperperiod, and the number of base-rate frames in the hyperperiod equals the number of frames in the period corresponding to the slowest rate data. The base frame rate, for example, may be 80 Hz, and the period of the slowest rate data and the hyperperiod, for example, may be 1 second. Hence, there are 80 base-rate frames with the hyperperiod of 1 second.

Data is produced in groups of data packets, where each group has a size (PS) and a type of integrity check. The hardware and software used to transmit data to and from the communication bus imposes a two base-frame latency between the time a node (module instance) produces (writes) data and the time that the data is available to a consuming (reading) node. Hence, data produced in frame 0 of a hyperperiod will be available for consumption in frame 2 of the same hyperperiod; while data produced in frame 79 of a hyperperiod will be available for consumption in frame 1 of the next hyperperiod. However, it should be understood that the scheduler described below can handle any base frame latency.

Table 1 gives information about six example data rates.

TABLE 1
Available Data Rates

| | | | | Date | |
|---|---|---|---|---|---|
| | | | | Movement | |
| | Rate | Frames/ | Periods/ | per | Non-eligible |
| Rate # | (Hz) | Period | Hyperperiod | Hyperperiod | Frame # |
| 1 | 80 | 1 | 80 | 20PS | — |
| 2 | 40 | 2 | 40 | 40PS | 1, 3, 5, . . . , 79 |
| 3 | 20 | 4 | 20 | 20PS | 3, 7, 11, . . . , 79 |
| 4 | 10 | 8 | 10 | 10PS | 7, 15, . . . , 79 |
| 5 | 5 | 16 | 5 | 5PS | 15, 31, . . . , 79 |
| 6 | 1 | 80 | 1 | 1PS | 79 |

In the above table, the second column is the data rate. The third column is the number of frames that are available in a period to transmit data packets at the corresponding data rate. The fourth column is the number of periods per hyperperiod (i.e., the number of times that any data packet can be transmitted per hyperperiod, given that, for data rates less than 80, all frames but the last frame within each period are suitable to transmit the data packet once and that a data packet can be split across suitable frames within each period). The fifth column specifies the number of times a group of data packets with size PS can be transmitted in a hyperperiod. The sixth column designates the frames that are ineligible to transmit data packets at the corresponding data rate during a hyperperiod.

Frame 79 in each period is ineligible due to latency. Hence, where there are two frames per period as in the case of rate 2, half of the frames of a hyperperiod are ineligible for the transmission of data packets. Where there are four frames per period as in the case of rate 3, ¼ of the frames of a hyperperiod are ineligible for the transmission of data packets.

Thus, for data produced at a rate slower than the base frame rate, the system imposes a rule that no data for that rate can be written to the bus during the last base-rate frame of the period for that data. Due to latency requirements, this rule is necessary to insure that all data transmitted for a group will be available in the consuming nodes at the start of the “next” period. Hence, the system can guarantee that for all data rates slower than the base frame rate, the group's data cannot be transmitted in the last frame of the period. Therefore, for 40 Hz data, there are only 40 frames per hyperperiod where transmission is allowed, whereas for 1 Hz data, there are 79 frames where transmission is allowed.

### Parameter Calculations

For the base frame rate (rate # 1) and for half of the base frame rate (rate # 2), the scheduler has no flexibility but to pass the entire data packet in each eligible frame of the hyperperiod. Therefore, this requirement, in turn, means fixed the produce and consume loads for each module for each frame. This requirement is given by the following equations:

$$\begin{matrix}{LMFT}_{m , f} = {\sum }_{p = 1}^{P} {\sum }_{r = 1}^{r = 2} {PS}_{p} \cdot {PR}_{p , r} \cdot {RF}_{r , f} \cdot {PMT}_{p , m} ∀ m , ∀ f & ( 1 ) \\ {LMFR}_{m , f} = {\sum }_{p = 1}^{P} {\sum }_{r = 1}^{r = 2} {PS}_{p} \cdot {PR}_{p , r} \cdot {PMR}_{p , m} \cdot ( {\sum }_{{f}^{′} = 0}^{F - 1} {RF}_{r , {f}^{′}} \cdot {TR}_{{f}^{′} , {f}^{′}} ) ∀ m , ∀ f & ( 2 )\end{matrix}$$

where LMFT_{m,f} is a calculated parameter indicating the fixed transmission/produce load in frame f for module m, where LMFR_{m,f} is a calculated parameter indicating the fixed consume load in frame f for module m, PSₚ is the size of a data packet (word) and is a known parameter, PR_{p,r} is the data packet rate relationship binary matrix and is a known parameter, RF_{r,f} is the rate frame suitability binary matrix and is a known parameter, PMT_{p,m} is the data packet module relationship binary matrix for production and is a known parameter, PMR_{p,m} is the data packet module relationship binary matrix for consumption and is a known parameter, TR_{f′,f} is the transmission-consumption relationship matrix for frames and is a known parameter, m is a module index, M is the total number of modules and is a known parameter, f is a frame index, F is the total number of frames in a hyperperiod and is a known parameter, p is a data packet group index, P is the total number of data packet groups to be scheduled (number of times equal to their data rate) in a hyperperiod and is a known parameter, r is a rate index, and R is the total number of rates and is a known parameter.

Using the example of Table 1, the rate frame suitability binary matrix RF_{r,f} is a matrix having, for example, 80 columns, one for each of the 80 frames in a hyperperiod, and six rows, one for each of the six rate numbers. A binary 1 indicates that a frame is eligible for the transmission of data at the corresponding rate number, and a binary 0 indicates that a frame is not eligible for the transmission of data at the corresponding rate number.

The transmission data packet module relationship binary matrix PMT_{p,m} indicates which data packet group identification number PIDₚ is assigned to which module, where, for example, each column corresponds to a different module as designated by its module identification number MIDₘ and where each row corresponds to a different data packet group as designated by its data packet group identification number PIDₚ. A binary one indicates that a module can transmit a data packet having the corresponding data packet group identification number and a binary 0 indicates that a module cannot transmit a data packet having the corresponding data packet group identification number.

The reception data packet module relationship binary matrix PMR_{p,m} indicates which data packet group identification number PIDₚ is assigned to which module, where, for example, each column corresponds to a different module as designated by its module identification number MIDₘ and where each row corresponds to a different data packet group as designated by its data packet group identification number PIDₚ. A binary one indicates that a module can receive a data packet having the corresponding data packet group identification number and a binary 0 indicates that a module cannot receive a data packet having the corresponding data packet group identification number.

The data packet rate relationship binary matrix PR_{p,r} is similarly constructed to show which data packet group identification number correspond to which rate #s, and the transmission consumption relationship matrix TR_{f′,f} indicates the relationship between the frame identifications between produce and consume frames and is used to take care of the two frame latency discussed herein. The columns of this matrix corresponds to consume frame IDs and the rows of this matrix correspond to produce frame IDs. Thus, a 1 at the intersection between column FID 2 and row FID 0 indicates the two frame latency. Other latencies could instead apply.

The consume load on a module can be from many different modules, may be on different buses, and is implicitly addressed white calculating the fixed consume load for each module. The fixed produce loads for individual modules decide the fixed produce load on the corresponding bus as given by the following equation:

$${LFB}_{b , f} = {\sum }_{p = 1}^{P} {\sum }_{r = 1}^{r = 2} {PS}_{p} \cdot {PR}_{p , r} \cdot {RF}_{r , f} \cdot ( {\sum }_{m = 1}^{M} {PMT}_{p , m} \cdot {BMT}_{m , b} ) ∀ b , ∀ f \qquad ( 3 )$$

where LBF_{b,f} is a calculated parameter indicating the fixed transmission/produce load in frame f on bus b, BMT_{m,b} is the bus-module relationship binary matrix for production and is a known parameter, b is a bus index, and B is the total number of buses and is a known parameter.

The bus module relationship binary matrix BMT_{m,b} indicates which module may transmit on which bus, where, for example, each column corresponds to a different bus as designated by its bus identification number BIDₘ and where each row corresponds to a different module as designated by its module identification number MIDₘ. A binary one indicates that a module can transmit on the corresponding bus, and a binary 0 indicates that a module cannot transmit over a corresponding bus.

If the size of a packet is less than twice of the chunk size, the packet cannot be split into more than one frame per period. Hence, the modified chunk size for such a packet will be equal to the packet size as given in the following equations:

TCSₚ=PSₚ ∀p:PSₚ<2CS (4)

TCSₚ=CS ∀p:PSₚ≧2CS (5)

where TCSₚ is a calculated parameter indicating the modified chunk size for packet p, and CS is the chunk size and is a known parameter.

The size of a data packet is in words. As indicated herein, a data packet can be split across suitable frames within each period. The pieces of the data packet after the split are referred to as chunks. A limit is imposed on the minimum size of a chunk. This limit is called the chunk size. For example, if the chunk size is 40, a data packet with a size of 90 can only be split into a maximum of two chunks because the size of each chunk must be at least 40. In the case where the data packet group size PS is less than the minimum chunk size, the entire data packet should be scheduled in single frame.

The maximum number of frames per period in which packet group data can be passed will depend upon the packet group size and the chunk size as given by the following equation:

$${MA}_{p} = ⌊ \frac{{PS}_{p}}{{TCS}_{p}} ⌋ ∀ p \qquad ( 6 )$$

where └ ┘ is the round down operator and MAₚ is a calculated parameter indicating the maximum number of frames per period in which data packet p can split. The calculated parameter MAₚ gives the upper limit on the number of frames allowed per period for packet p, depending upon the packet group size and packet rate.

### Constraints

Packet group data PSₚ for each data packet p would be produced on a corresponding bus every period. The frames per period and the eligibility of frames for each packet is addressed by the following constraint:

$${\sum }_{f = ( o - 1 ) ( {RP}_{p} )}^{( o ) ( {RP}_{p} ) - 1} ( {y}_{p , f} ) ( {\sum }_{r = 3}^{R} ( {PR}_{p , r} ) ( {RF}_{r , f} ) ) \geq 1 ∀ p , ∀ ( o \leq {OP}_{p} ) \qquad ( 7 )$$

where RPₚ is the number of frames per period and is a known parameter, y_{p,f} is a binary integer variable that indicates whether or not data packet p is transmitted in frame f, OPₚ is the number of periods per hyperperiod and is a known parameter, and o is a period index.

Also, the number of frames used per period to produce data should be less than the maximum allowed number MAₚ even though the number of eligible frames per period are greater in number, as given by the following constraint:

$${\sum }_{f = ( o - 1 ) ( {RP}_{p} )}^{( o ) ( {RP}_{p} ) - 1} ( {y}_{p , f} ) ( {\sum }_{r = 3}^{R} ( {PR}_{p , r} ) ( {RF}_{r , f} ) ) \leq {MA}_{p} ∀ p , ∀ ( o \leq {OP}_{p} ) \qquad ( 8 )$$

For rates with a rate number r greater than 2, there is flexibility to split the packet group data within eligible frames per period to level the produce and consume load of each module. While splitting the packet group data, care must be exercised to insure that the data is produced only within eligible frames of the rate to which the packet belongs as given by the following constraint:

$${sp}_{p , f} \leq ( {PS}_{p} ) ( {y}_{p , f} ) ( {\sum }_{r = 3}^{R} ( {PR}_{p , r} ) ( {RF}_{r , f} ) ) ∀ p , ∀ f \qquad ( 9 )$$

where sp_{p,f} is an integer variable designating the size of the data packet p in frame f. Also, the data produced for each packet group p, within eligible frames of the packet group p, should not be less than the allowed chunk size as given by the following constraint:

$${sp}_{p , f} \geq ( {TSC}_{p} ) ( {y}_{p , f} ) ( {\sum }_{r = 3}^{R} ( {PR}_{p , r} ) ( {RF}_{r , f} ) ) ∀ p , ∀ f \qquad ( 10 )$$

The sum of the data produced within the eligible frames of the packet (the eligible frames will depend upon the rate of the packet) for each period should be equal to the total packet group size for each period as given by the following constraint:

$${PS}_{p} = {\sum }_{f = ( o - 1 ) ( {RP}_{p} )}^{( o ) ( {RP}_{p} ) - 1} {sp}_{p , f} ∀ p , ∀ ( o \leq {OP}_{p} ) \qquad ( 11 )$$

The total produce load in each frame for each bus will be the sum of the fixed produce load (due to base frame rate and half of base frame rate, i.e., r=1 r=2) and the flexible produce load (because of rate numbers r>2) from the modules which are connected to the bus to produce the data. This total produce load should be less than the allowed load as given by the following constraint:

$${LFB}_{b , f} + {\sum }_{p = 1}^{P} {\sum }_{r = 3}^{R} ( {sp}_{p , f} ) ( {PR}_{p , r} ) ( {\sum }_{m = 1}^{M} ( {PMT}_{p , m} ) ( {BMT}_{m , b} ) ) \leq \frac{{BL}_{{max}_{b}}}{WS} ∀ b , ∀ f \qquad ( 12 )$$

where BLₘₐₓ _{_{b}} is the maximum load for transmission over a bus (byte) and is a known parameter, and WS is the word size (byte) and is a known parameter.

The total produce load for every module m in each frame f will again be the sum of the fixed loads (due to base frame rate and half of base frame rate, i.e., r=1 and r=2) and the flexible produce load (because of rate numbers r>2) as given by the following constraint:

$${lmt}_{m , f} = {LMFT}_{m , f} + {\sum }_{p = 1}^{P} {\sum }_{r = 3}^{R} ( {sp}_{p , f} ) ( {PR}_{p , r} ) ( {PMT}_{p , m} ) ∀ m , ∀ f \qquad ( 13 )$$

where lmt_{m,f} is a continuous variable designating the transmission load for module m in frame f (word). The total produce load should be less than the NIC (Network Interface Controller) load if the module m is a NIC module. This requirement is captured by the following constraint:

$${lmt}_{mf} \leq {MNIC}_{m} ( \frac{NICL}{WS} ) + ( 1 - {MNIC}_{m} ) {\sum }_{b = 1}^{B} ( {BMT}_{m , b} ) ( \frac{{BL}_{{max}_{b}}}{WS} ) ∀ m , ∀ f \qquad ( 14 )$$

where MNICₘ is the module NIC relationship binary vector and is a known parameter, and NICL is the maximum load for transmission if module m is a NIC module and is a known parameter. This constraint is relaxed if the module m is not a NIC module.

The module NIC relationship binary vector MNICₘ is a vector having a number of elements corresponding to the number of modules in the network such that a binary 1 for a corresponding module indicates that this module is a NIC module and a binary 0 for a corresponding module indicates that this module is not a NIC module.

The peak produce load in any frame for a Flexi module m will be calculated using the following constraint:

flmtₘ≧lmt_{m,f} ∀(m:MFLXₘ=1),∀f (15)

where flmtₘ is a continuous variable designating the peak transmission load for Flexi module m, and MFLXₘ is a binary vector that indicates whether module m is a Flexi module and is a known parameter. The peak produce load for a Flexi module is a maximum produce load among all of the frames.

A flexi module is used herein to mean a module where the separate produce and consume peak loads can be controlled and/or reduced independently. In a non-flexi module, only the sum of the produce and consume peak loads can be controlled. Whether the module is a flexi module or a non-flexi module is known a priori.

The binary vector MFLXₘ is a vector having a number of elements corresponding to the number of modules in the network such that a binary 1 for a corresponding module indicates that this module is a flexi module and a binary 0 for a corresponding module indicates that this module is not a flexi module.

As the objective of the formulation for a Flexi module is to minimize peak produce loads and consume loads, the peak produce load should not be greater than the maximum produce load at any time, even though the above set of constraints do not force that objective. Similarly, the total consume load for a module m is the sum of the fixed and flexible consume loads. It should be noted that the consume load on module m can be from many different modules and may be on different buses, which is implicitly addressed in the following set of constraints:

$${lmr}_{m , f} = {LMFR}_{m , f} + {\sum }_{p = 1}^{P} {\sum }_{r = 3}^{R} ( {PR}_{p , r} ) ( {PMR}_{p , m} ) ( {\sum }_{{f}^{′} = 1}^{F} ( {sp}_{p , {f}^{′}} ) ( {TR}_{{f}^{′} , f} ) ) ∀ m , ∀ f \qquad ( 16 )$$

where lmr_{m,f} is a continuous variable designating the consume load for module m in frame f. Constraint (16) also takes care of two-frame latency.

The peak consume load for a Flexi module is calculated along similar lines as constraint (15), and is given by the following constraint:

flmrₘ≧lmr_{m,f} ∀(m:MFLXₘ=1),∀f (17)

where flmrₘ is a continuous variable designating the peak consumption load for Flexi module m.

For Non-Flexi modules, the objective is to minimize the peak sum of the produce and consume loads. The peak sum for Non-Flexi modules is calculated using the following constraint:

$${flm}_{m} \geq ( T ) ( {MPT}_{m} ) ( {lmt}_{m , f} ) + ( C ) ( {MPR}_{m} ) ( {lmr}_{m , f} ) ∀ ( m \text{:} {MFLX}_{m} = 0 ) , ∀ f \qquad ( 18 )$$

where flmₘ is a continuous variable designating the peak transmission and consumption load for Non-Flexi module m, T is a known binary parameter to orient the schedule as per produce load, MPTₘ is a module priority for transmission/production and is a known parameter, C is a known binary parameter to orient the schedule as per consume load, and MPRₘ is a module priority for receiving/consumption and is a known parameter.

The module priority is defined by the user based on system and domain knowledge.

In the set of constraints given by equation (18), the module priorities for transmission and consumption are considered along with packets T and C, which are used to orient the solution, because for Non-Flexi modules the objective is to minimize the peak sum of the consume and produce loads.

### Objective Function

The objective for a module load leveled bus scheduler is to find the produce load and consume load for each individual module and to minimize the peak produce and consume loads for all modules. Therefore, the objective function for the current formulation is given by the following equation:

$$min MLL = {\sum }_{m \text{:} {MFLX}_{m} = 0}^{M} \frac{{flm}_{m}}{{MS}_{m}} + T [ {\sum }_{m \text{:} {MFLX}_{m} = 1}^{M} \frac{( {MPT}_{m} ) ( {flmt}_{m} )}{{MS}_{m}} ] + [ {\sum }_{m \text{:} {MFLX}_{m} = 1}^{M} \frac{( {MPR}_{m} ) ( {flmr}_{m} )}{{MS}_{m}} ] \qquad ( 19 )$$

where MSₘ is the measure of the module strength and is a known parameter. The module strength MSₘ of module m is essentially the processing power of module m.

The objective function given by equation (19) has three terms on the right side. The first term is for Non-Flexi modules, while the last two terms are for Flexi modules. It can be seen from the objective function of equation (19) that (i) for Non-Flexi modules, the peak sum of the produce and consume load is minimized, and (ii) for Flexi modules, the peak produce load and the peak consume load are minimized separately.

The measure of the strength of a module is used to calculate the actual load on the module. The priority of the module for transmission and consumption is considered separately, which adds flexibility into the formulation to allow the user to give different priority to the same module for transmission and consumption. Also, the parameters T and C in the objective function of equation (19) and in constraint (18) allow the solution to be oriented as per the need of the user.

The following values may be set for T and C to produce a desired result. If T=1 and C=0, the scheduler will level only the produce load of each module. If T=0 and C=1, the scheduler will level only the consume load of each module. If T=1 and C=1, the scheduler will simultaneously level both the produce load and the consume load of each module. Other values of T and C can be also be used to orient the solution.

The scheduler described herein is a static scheduler such that, once the continuous variables are determined from the objective function, they are not re-determined unless the applications running on the module, the module priority, strength, or nature (e.g., flexi vs. non-flexi) is changed If there is change, the schedule should be regenerated.

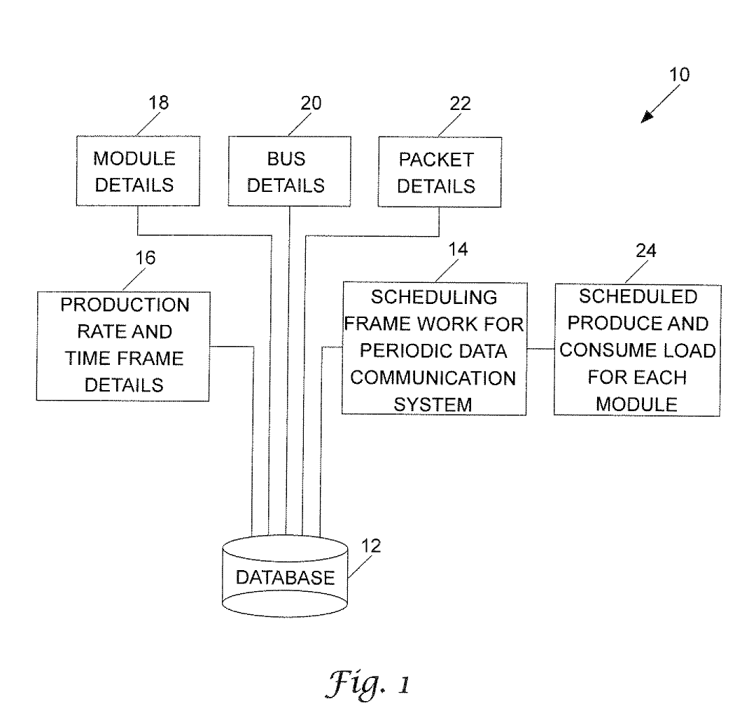

As shown in FIG. 1, an optimized module load leveling scheduler 10 includes a database 12 and a processor 14 that supports the scheduling framework for a periodic data communication system. Stored in the database 12 are production rate and time frame details 16, module details 18, bus details 20, and packet details 22. The processor 14 may be a computer, an application specific integrated circuit (ASIC), a programmable filed array, or any other device suitable for executing the processes described herein.

The production rate and time frame details 16 include the parameters F, R, C, T, RF_{r,f}, and T_{f,f}.

The module details 18 include the parameters M, MFLXₘ, MNICₘ, MPRₘ, MPTₘ, MSₘ, and NICL.

The bus details 20 include the parameters B and BLₘₐₓ.

The packet details 22 include the parameters P, CS, OPₚ, PSₚ, RPₚ, and WS.

The parameter BMT_{m,b} may be included in either the module details 18 or the bus details 20.

The parameters PMR_{p,m}, and PMT_{p,m}, may be included in either the module details 18 or the packet details 22.

The parameter PR_{p,r} may be included in either the packet details 22 or the production rate and time frame details 16.

The processor 14 determines the produce and consume load (lmt_{m,f} and lmr_{m,f}) for each module in each frame which minimizes the peak produce and consume loads 24 (flmrₘ, flmtₘ, and flmₘ) of each module and provides the minimum peak produce and consume loads 24 of each module (flmrₘ, flmtₘ, and flmₘ) as an output.

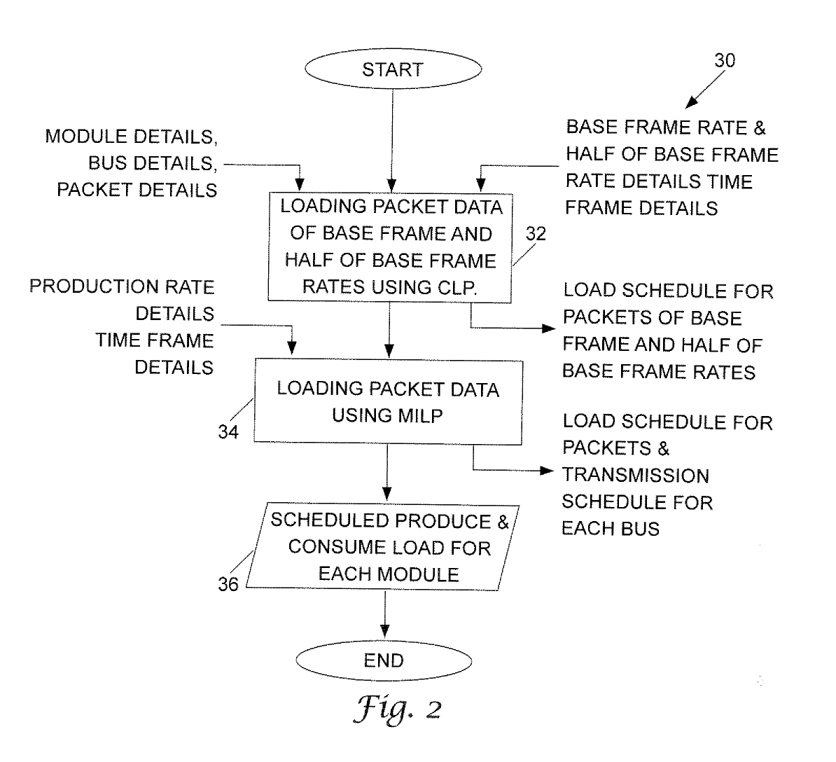

In determining the produce and consume load (lmt_{m,f} and lmr_{m,f}) for each module in each frame which minimizes the peak produce and consume loads 24 of each module (flmrₘ, flmtₘ, and flmₘ), the processor 14 executes a process 30 shown in FIG. 2. Accordingly, the process 30 at a block 32 loads packet data of base frame and half base frame rates into time frames using constraint logic programming techniques. For this purpose, the block 32 relies on the production rate and time frame details 16, the module details 18, the bus details 20, the packet details 22, and equations (1)-(3). Equations (1)-(3) are constraints and can be solved using constraint base programming techniques.

Using equations (1)-(3), the block 32 calculates a load schedule by module, frame, and bus for packets of the base frame and of frames at half of the base frame rate. Using equations (4)-(6), a block 34 calculates MAₚ, the maximum number of frames per period in which data packet p can be split, and TCSₚ, the modified chunk size for this packet p.

The process 30 at the block 34 also calculates an optimal load schedule by module and frame for other frame rates using mixed integer linear programming techniques. For this purpose, the block 34 relies on the production rate and time frame details 16, the module details 18, the bus details 20, the packet details 22, and the linear equations (13), (16), and (19). In making these calculations, the block 34 applies appropriate ones of the constraints (4)-(12); (14), (15), (17), and (18).

The process 30 at a block 36 finally schedules the produce and consume load for each module. For this purpose, the block 36 uses the load schedules calculated at blocks 32 and 34. These load schedules can include, for example, the transmission load for each frame by bus, the consume load for each frame by module, and the produce load for each frame by module. The consume and produce load schedules can also include the peak load for each module.

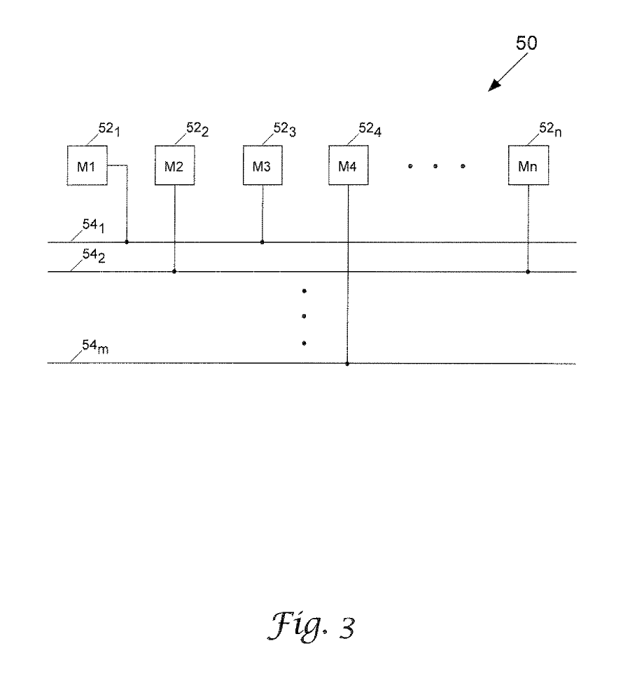

FIG. 3 illustrates a network 50 having modules 52₁, 52₂, 52₃, 52₄, . . . , 52ₙ, connected variously to buses 54₁, 54₂, . . . , 54ₘ. Some of the modules 52₁, 52₂, 52₃, 52₄, . . . , 52ₙ may be flexi modules, some of the modules 52₁, 52₂, 52₃, 52₄, . . . , 52ₙ may be non-flexi modules, some of the modules 52₁, 52₂, 52₃, 52₄, . . . , 52ₙ may be network interface controller modules, some of the modules 52₁, 52₂, 52₃, 52₄, . . . , 52ₙ may be non network interface controller modules, and one of the modules 52₁, 52₂, 52₃, 52₄, . . . , 52ₙ may perform the functions of a load scheduler in accordance with the arrangement of FIG. 1 and with the program of FIG. 2.

Modifications of the present invention will occur to those practicing in the art of the present invention. Accordingly, the description of the present invention is to be construed as illustrative only and is for the purpose of teaching those skilled in the art the best mode of carrying out the invention. The details may be varied substantially without departing from the spirit of the invention, and the exclusive use of all modifications which are within the scope of the appended claims is reserved.

We claim:

1. A method of scheduling periodic communication between modules of data in time frames having a plurality of frame rates including a base frame rate, the method comprising:
determining a first load schedule for data packets of base frame and half base frame rates using constraint logic programming techniques;
determining a second load schedule for data packets of other frame rates using mixed integer linear programming techniques; and,
scheduling produce and consume loads for each of the modules based on the first and second load schedules.

2. The method of claim 1 wherein the determining of a first load schedule for data packets of base frame and half base frame rates using constraint logic programming techniques comprises:
determining a fixed produce load by frame and module based on a predetermined data packet size, a predetermined relationship between packet and rate, a predetermined relationship between frame and rate, and a predetermined relationship between packet and module during produce; and,
determining a fixed consume load by frame and module based on the predetermined data packet size, the predetermined relationship between packet and rate, a predetermined relationship between frame and rate, a predetermined relationship between packet and module during consume, and a predetermined relationship between produce and consume frames.

3. The method of claim 2 wherein the determining of a first load schedule for data packets of base frame and half base frame rates using constraint logic programming techniques further comprises:
determining a fixed produce load by frame and bus based on the predetermined data packet size, the predetermined relationship between packet and rate, the predetermined relationship between frame and rate, a predetermined relationship between packet and module during produce, and a predetermined relationship between bus and module during produce.

4. The method of claim 2 wherein the determining of a second load schedule for data packets of other frame rates using mixed integer linear programming techniques comprises:
determining a non-fixed produce load by frame and module based on the fixed produce load, a variable related to a size of a data packet in a frame, the predetermined relationship between packet and rate, and the predetermined relationship between packet and module during produce; and,
determining a non-fixed consume load by frame and module based on the fixed consume load, the variable related to a size of a data packet in a frame, the predetermined relationship between packet and rate, the predetermined relationship between packet and module during consume, and the predetermined relationship between produce and consume frames.

5. The method of claim 4 wherein the determining of a second load schedule for data packets of other frame rates using mixed integer linear programming techniques further comprises:
minimizing a peak sum of produce and consume load for non-flexible modules, a peak consume load for a flexible module, and a peak produce load for a flexible module according to an objective function, wherein a flexible module comprises a module that is able to separately control peak produce and consume loads, and wherein a non-flexible module comprises a module that is not able to separately control peak produce and consume loads.

6. The method of claim 5 wherein the objective function is based on the peak sum of produce and consume load for non-flexible modules, the peak consume load for a flexible module, the peak produce load for a flexible module, predetermined strengths of the modules, and predetermined module priorities of the modules.

7. The method of claim 6 wherein the predetermined module priorities comprise independent produce and consume priorities.

8. The method of claim 6 wherein the predetermined module priorities are based on module type, applications running on the module, criticality, cost, and strength.

9. The method of claim 5 wherein the objective function is arranged to be oriented so that the relative importance between the peak consume load and the peak produce load can be adjusted.

10. The method of claim 5 wherein the peak sum of produce and consume load for non-flexible modules is constrained to be no less than at least one of the non-fixed produce load and the non-fixed consume load, wherein the peak consume load for a flexible module is constrained to be no less than the non-fixed consume load, and wherein the peak produce load for a flexible module is constrained to be no less than the non-fixed produce load.

11. The method of claim 5 wherein the variable related to a size of a data packet in a frame is constrained to be no greater than a first quantity and no less than a second quantity, wherein the first quantity is based on the predetermined data packet size, the predetermined relationship between packet and rate, the predetermined relationship between frame and rate, and a variable that indicates whether or not a data packet is transmitted in a frame, wherein the second quantity is based on a chunk size for a data packet, the predetermined relationship between packet and rate, the predetermined relationship between frame and rate, and the variable that indicates whether or not a data packet is transmitted in a frame, and wherein the chunk size is indicative of portions of a data packet that can be split between frames.

12. The method of claim 11 wherein the chunk size comprises a first chunk size, wherein the first chunk size is constrained to be equal to the predetermined data packet size if the predetermined data packet size is less than twice a second chunk size, wherein the first chunk size is constrained to be equal to the second chunk size if the predetermined data packet size is greater than twice second the chunk size, and wherein the second chunk size comprises a predetermined portion of a data packet that can be split off from a data packet.

13. The method of claim 11 wherein a third quantity is constrained to be no less than one, wherein a fourth quantity is constrained to be no greater than a maximum number of frames per period in which a data packet can be split, wherein the third quantity is based on the variable that indicates whether or not a data packet is transmitted in a frame, the predetermined relationship between packet and rate, and the predetermined relationship between frame and rate, and wherein the fourth quantity is based on the variable that indicates whether or not a data packet is transmitted in a frame, the predetermined relationship between packet and rate, and the predetermined relationship between frame and rate.

14. The method of claim 13 wherein the maximum number of frames per period in which a data packet can be split is equal to a rounded down division of the predetermined data packet size by the chunk size.

15. The method of claim 5 wherein the determining of a first load schedule for data packets of base frame and half base frame rates using constraint logic programming techniques further comprises:
determining a fixed produce load by frame and bus based on the predetermined data packet size, the predetermined relationship between packet and rate, the predetermined relationship between frame and rate, a predetermined relationship between packet and module during produce, and a predetermined relationship between bus and module during produce.

16. The method of claim 15 wherein a quantity is no greater than a factor that is dependent on a predetermined maximum load that can be transmitted on a bus, wherein the quantity is based on the fixed produce load, the variable related to a size of a data packet in a frame, the predetermined relationship between packet and rate, the predetermined relationship between packet and module during produce, and the predetermined relationship between bus and module during produce.

17. The method of claim 15 wherein the non-fixed produce load is no greater than a quantity, and wherein the quantity is dependent on a predetermined maximum load that can be transmitted on a bus, the predetermined relationship between bus and module during produce, a predetermined relationship between each module and a corresponding network interface controller, and a predetermined maximum produce load for network interface controller modules.

18. The method of claim 5 wherein the predetermined data packet size is equal to the sum of the variable related to a size of a data packet in a frame belonging to a period for all transmission periods that are no greater than a predetermined number of periods per hyperperiod.
